(19) United States
(12) Patent Application Publication
(10) Pub. No.: US 2003/0086756 A1
(43) Pub. Date: May 8, 2003

(54) Modular linkage system

(76) Inventors: Jason K. Trotter, Des Plaines, IL (US); Robert K. Dutzi, Palatine, IL (US); Eric G. Parker, Winnetka, IL (US)

Correspondence Address: Tait R. Swanson, Fletcher, Yoder & Van Someren, P.O. Box 692289, Houston, TX, 77269-2289, US

(21) Appl. No.: 10/066,220

(22) Filed: Nov. 7, 2001

(51) Int. Cl. F16B 7/00; F16B 13/00

(52) U.S. Cl. 403/293

(57) ABSTRACT

An integral or multi-component linkage structure formed at least partially by extrusion techniques to ensure uniformity and modularity. The structure includes a body section and a head section, which may be integrally or separately formed via extrusion or molding techniques. The body section may be extruded longitudinally or laterally relative to the longitudinal axis of the structure. The head section may be integrally formed with the body section, or it may be separately formed by extrusion or molding techniques for insertion into a receptacle of the body section.

### BACKGROUND OF THE INVENTION

The present invention relates generally to the field of mechanical linkages, and more particularly, to a universal or modular system for such linkages and devices. The present invention specifically provides an integral or multi-component linkage structure, which is formed at least partially by extrusion techniques to provide uniformity and modularity.

Conventional linkages generally have multiple components, such as a socket arm and socket head or a linkage arm and joint structure. These components are typically manufactured by molding/casting one component at a time. Even the devices and linkages that do embody integral one-piece structures are typically formed by molding/casting one component at a time. Accordingly, the foregoing manufacturing techniques are generally time consuming and cost inefficient, while the resulting structures are non-uniform and non-interchangeable.

There is a need, therefore, for a manufacturing technique that produces a uniform or modular linkage system. There is a particular need for a modular linkage system that can be manufactured in a more efficient manner. For example, it would be advantageous to reduce the number of manufacturing steps, time requirements, and tooling costs for a particular linkage system or multi-component device.

### SUMMARY OF THE INVENTION

The present technique provides an integral or multi-component structure, or linkage system, formed at least partially by extrusion techniques to ensure uniformity and modularity. The structure includes a body section and a head section, which may be integrally or separately formed via extrusion or molding techniques. The body section may be extruded longitudinally or laterally relative to the longitudinal axis of the structure. The head section may be integrally formed with the body section, or it may be separately formed by extrusion or molding techniques for insertion into a receptacle of the body section.

In one aspect, the present technique provides a mechanical linkage comprising an elongated extruded member having a structural cross-section and a linkage end. The structural cross-section is configured to support the linkage end under a mechanical load.

In another aspect, the present technique provides a modular linkage system comprising an extruded arm having first and second sockets at opposite lengthwise ends of the extruded arm. The first and second sockets have a geometry configured for multi-angular orientations.

In another aspect, the present technique provides a method of forming a modular linkage assembly comprising extruding an elongated member having at least one linkage section at one of opposite lengthwise ends of the elongated member.

### BRIEF DESCRIPTION OF THE DRAWINGS

The foregoing and other advantages of the invention will become apparent upon reading the following detailed description and upon reference to the drawings in which:

FIG. 1 is a side view of an exemplary linkage assembly of the present technique;

FIG. 2 is a side view of the linkage assembly having head members disposed in opposite ends of the linkage assembly;

FIG. 3 is a side view of the linkage assembly having head members oriented 90 degrees apart in the opposite ends;

FIG. 4 is a perspective view of an exemplary head member having a polygonal receptacle and a square attachment portion;

FIG. 5 is a perspective view of an alternate head member having a circular receptacle and the square attachment portion;

FIG. 6 is a perspective view of an alternate head member having a square receptacle and the square attachment portion;

FIG. 7 is a perspective view of an alternate head member having an open-ended hook-shaped structure and the square attachment portion;

FIG. 8 is a perspective view of an alternate head member having a ball shaped joint structure and the square attachment portion;

FIG. 9 is a perspective view of an exemplary linkage member of the linkage assembly having a square cross section;

FIG. 10 is a perspective view of an alternate linkage member having a multisided cross section geometrically characterized by symmetrically overlaying a pair of square cross sections;

FIG. 11 is a perspective view of an alternate linkage assembly having the open-ended hook-shaped structure illustrated in FIG. 7 and a U-shaped linkage member;

FIG. 12 is a perspective view of an exemplary stock structure for making universal devices or linkages;

FIG. 13 is a perspective view of an exemplary member cut from the stock structure illustrated in FIG. 12;

FIG. 14 is a perspective view of the member illustrated in FIG. 13 twisted about a mid-portion to provide an angular differential between opposite ends of the member; and

FIGS. 15 and 16 are perspective views of alternate crosswise extruded linkages.

### DETAILED DESCRIPTION OF SPECIFIC EMBODIMENTS

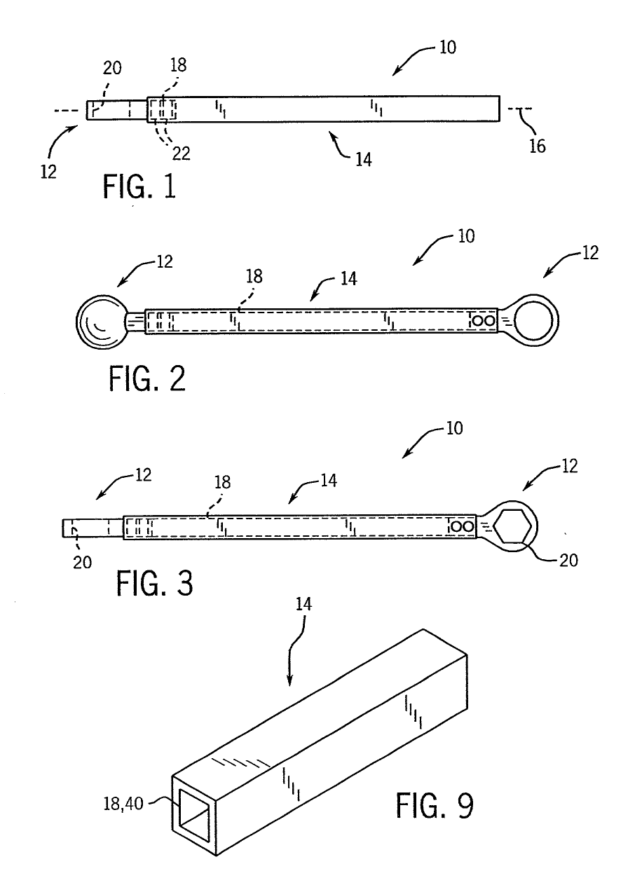

Turning now to the drawings and referring first to FIG. 1, an assembly is illustrated in accordance with the present technique and designated generally by reference numeral 10. The assembly 10 includes a head member 12 disposed in a linkage member 14. The head and linkage members 12 and 14 may embody one or more of a variety of materials, such as metal, plastic, rubber, composites, ceramics or any other suitable materials. For example, the head and linkage members 12 and 14 may be extruded or cast from Aluminum, Magnesium, or any other suitable material. Moreover, the geometry of the head member 12 and the linkage member 14 may embody a variety of structural features and receptacles, which may be used for a single or multiple joint assembly, linkage structure, or any other desired device.

In an exemplary embodiment, the linkage member 14 is extruded longitudinally relative to an axis 16 of the assembly 10. This extrusion process forms a modular cavity 18 throughout the entire length of the linkage member 14. The linkage member 14 also may be formed by a molding process, which forms the modular cavity 18 at one or both ends of the linkage member 14. The head member 12 is then inserted into the modular cavity 18 for use as a device or linkage member. For example, the head member 12 may comprise a receptacle 20 having a geometry configured for use as a linkage to a desired mechanical component, or for any other suitable mobile or stationary application. Depending on the desired use, the head member 12 may be permanently or temporarily fixed in the modular cavity 18 via welding, adhesive, magnetic bonding, staking, riveting, compression fitting, pins or bolts, a latch mechanism, a spring-loaded mechanism, or any other suitable attachment mechanism. For example, as illustrated in FIG. 1, the head member 12 has attachment receptacles 22 for coupling with the linkage member 14 via pins, bolts, or a spring-loaded mechanism.

As mentioned above, the linkage member 14 may be extruded longitudinally to form a uniform cross section, including the modular cavity 18 for the head member 12. As illustrated in FIG. 2, the assembly 10 has head members 12 disposed in opposite ends of the modular cavity 18. Any desired device structure or linkage mechanism may be disposed in these ends, including identical or different pairs of the head members 12 at any desired relative angle between such pairs. The assembly 10 illustrated in FIG. 2 has a ball joint structure as the head member 12 in the left end of the modular cavity 18, while the head member 12 embodies a ring-shaped receptacle at the right end of the modular cavity 18.

The assembly 10 illustrated in FIG. 3 has head members 12 disposed at different angles (e.g., 90 degrees apart) at the opposite ends of the modular cavity 18. Moreover, the receptacles 20 in the left and right head members 12 may have different geometries, such as a circular geometry at the left end and a polygonal geometry at the right end. The geometry of the modular cavity 18 controls the number of available positions for the head members 12. For example, the modular cavity 18 may have a square cross section to allow 90-degree position changes of the head members 12, as illustrated in FIG. 9.

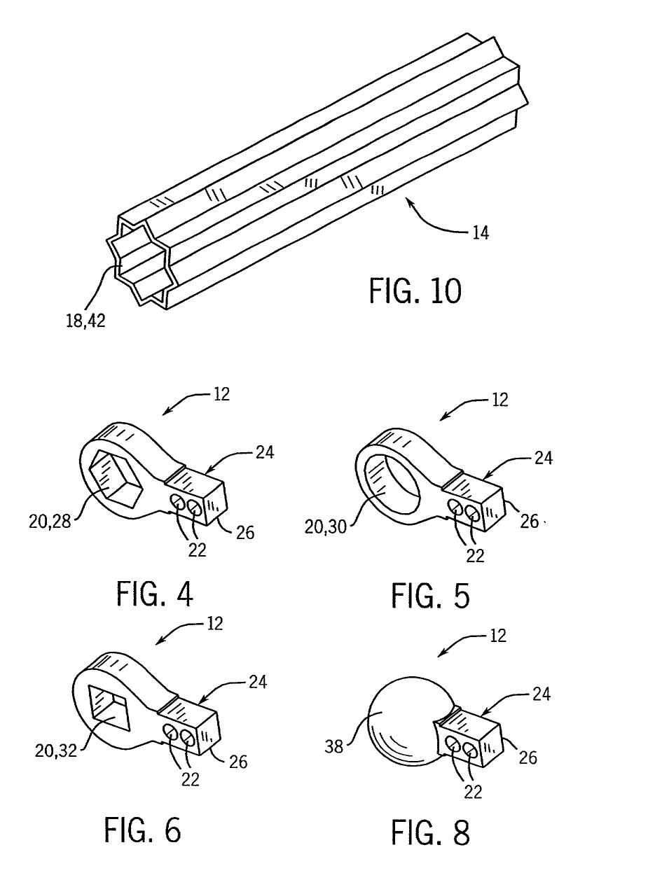

As mentioned above, the head member 12 may embody any desired device or linkage geometry and attachment portion for insertion into the modular cavity 18. FIGS. 4 through 8 illustrates exemplary head members 12, all of which include an attachment portion 24 having a square cross section 26 and the attachment receptacles 22. As illustrated, FIGS. 4 through 6 embody close-ended device or linkage structures having a generally flat geometry and the receptacle 20 extending through the flat geometry. In these close-ended configurations, the receptacle 20 embodies a polygonal cross section 28, a circular cross section 30, and a square cross section 32 in FIGS. 4, 5 and 6, respectively.

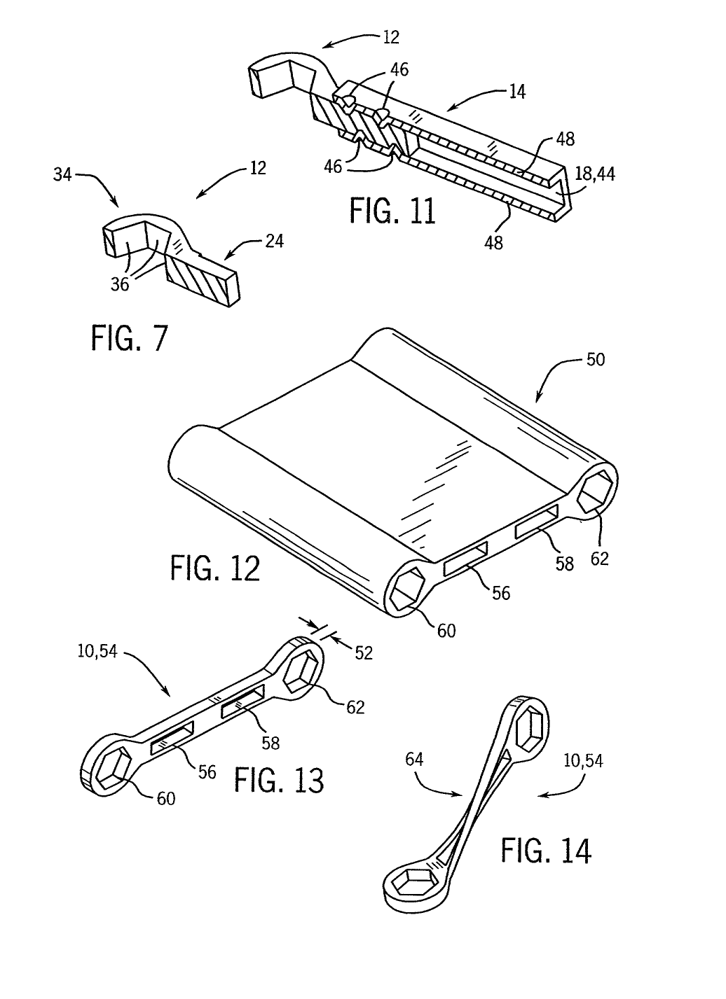

Alternatively, the head member 12 may have an open-ended device or linkage structure, as illustrated in FIG. 7. In this embodiment, the head member 12 has a square or rectangular attachment portion 24 and a hook-shaped portion 34, which may be used as a device or linkage structure. However, as illustrated, the hook shaped portion 34 has multiple flat sides 36 for interlocking with a desired structure having a matching polygonal geometry.

The head member 12 also may embody a variety of fixed or movable joint mechanisms, such as a ball joint, a pin joint, a needle joint, a nut and bolt joint, or any other desired mechanism. For example, as illustrated in FIG. 8, the head member 12 may embody a ball structure 38. The ball structure 38 may be configured for insertion into a socket or it may comprise an integral ball and socket assembly. For example, a studded ball structure may be molded in place within a socket or linkage structure. The foregoing joints also may embody a variety of flexible or firm materials, such as metals, plastics, rubber, and various elastomeric materials. For example, the head member 12 may embody an elastomeric or spherical joint, a bushing, an insulator, a grommet, a washer, a threaded receptacle, a threaded stud, or a variety of other joint assemblies.

The foregoing head members 12 may be removably or fixably disposed in the modular cavity 18 of a variety of linkage members 14, such as illustrated in FIGS. 9 and the 10. As mentioned above, the particular geometry of the modular cavity 18 may be varied to control the desired number of available angular positions for the head member 12. The linkage member 14 illustrated in FIG. 9 has a square cross section 40 to provide four angular positions disposed at 0 degrees, 90 degrees, 180 degrees and 270 degrees. Accordingly, the square attachment portion 24 of the head members 12 illustrated in FIGS. 4 through 8 allows the head members 12 to be rotated in increments of 90 degrees within the modular cavity 18. A rectangular geometry of the modular cavity 18 would reduce the number of available positions to two angular orientations corresponding to angular increments of 180 degrees. It should also be noted that the internal geometry may be twisted during extrusion to provide an angular differential between opposite ends of the linkage member 14. For example, the internal square geometry could be twisted 30 degrees, 45 degrees, or any desired angle over a length of extruded material.

The linkage member 14 illustrated in FIG. 10 has a multisided cross section 42 geometrically characterized by overlaying a pair of square cross sections at 45 degrees apart. Accordingly, the multisided cross section 42 essentially doubles the number of available angular orientations of the head member 12 by allowing angular increments of 45 degrees within the modular cavity 18. Although not illustrated, the linkage member 14 may have any number of symmetrically overlaid square cross sections to increase the number of available angular orientations.

The linkage members 14 illustrated in FIGS. 9 and 10 both have closed cross sections. However, the linkage member 14 may have any desired cross-section within the scope of the present technique. As illustrated in FIG. 11, the linkage member 14 has an open cross section 44 with a C-shaped or U-shaped geometry. The head member 12 is inserted into an end of the open cross section 44, where it may be removably or fixedly coupled to the linkage member 14. In this exemplary embodiment, the head member 12 is fixedly disposed within the modular cavity 18 by crimping 46 the linkage member 14 along outer edges 48.

The assembly 10 also can be formed by extruding a desired geometry 50, as illustrated in FIG. 12, and then cutting a desired length 52 of the desired geometry 50 to form a structure 54, as illustrated in FIG. 13. The resulting structure 54 embodies a crosswise-extruded linkage or joint structure, rather than a lengthwise-extruded (i.e., linkage member 14) as illustrated in FIGS. 9 and 10. The extruded geometry 50 may be cut with a saw, chopped with a die set and internal mandrels attached to a punch press, or cut with any other suitable cutting technique. The desired geometry 50 illustrated in FIG. 12 comprises a variety of structural features and device geometries, such as sockets, joints, and mechanical support structures. For example, the desired geometry 50 may include mechanical support structures 56 and 58 and device/linkage receptacles 60 and 62. As discussed above with reference to the head members 12 illustrated in FIGS. 4 through 7, the receptacles 60 and 62 may embody open or closed geometries with one or more symmetrically arranged sides (e.g., circle, square, polygonal, etc.). As illustrated, the receptacles 60 and 62 have polygonal geometries. The receptacles 60 and 62 may be used as mechanical linkages, as receptacles for the head members 12 illustrated in FIGS. 4 through 8, or for any other suitable linkage or device applications.

The structure 54 illustrated in FIG. 13 also may be twisted about a mid-portion 64 to provide different angular positions of the receptacles 60 and 62, as illustrated in FIG. 14. For example, the structure 54 may be heated and twisted 45 degrees, 90 degrees, or any desired angle to provide an angular differential between the receptacles 60 and 62. The twisting process also may involve annealing and tempering the material, among other suitable materials processing.

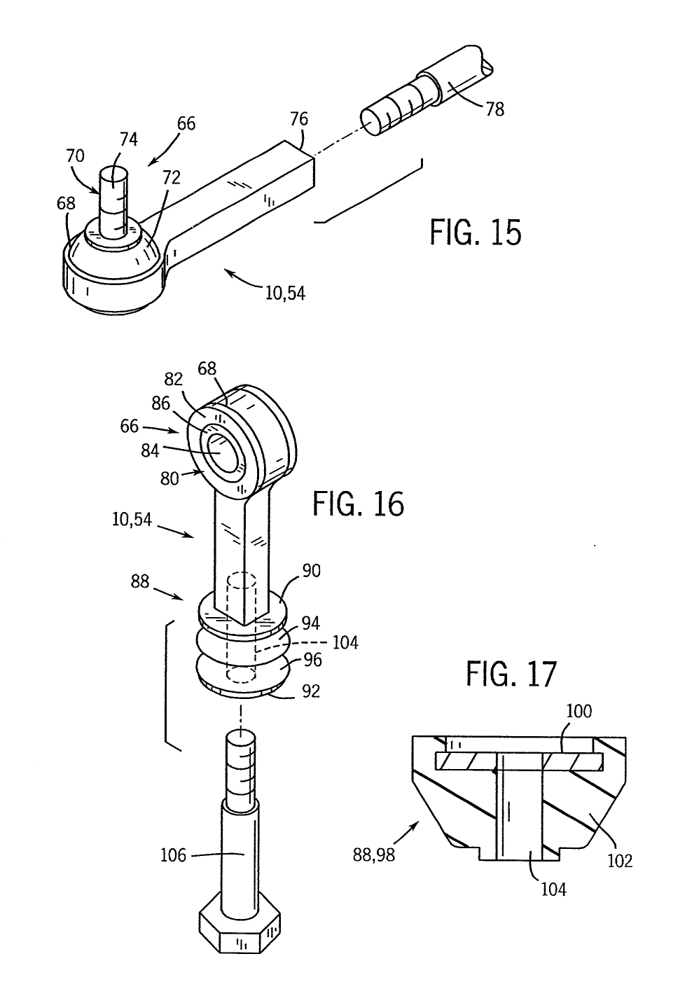

As noted above, the structure 54 is extruded crosswise to form one or more receptacles, such as the receptacles 60 and 62, which may comprise integral or separately inserted joint assemblies. For example, one or both of the receptacles 60 and 62 may support a bushing, a grommet, an insulator, a threaded stud, a threaded receptacle, or any desired metallic or elastomeric joint member. FIGS. 15 and 16 are perspective views of alternate crosswise-extruded structures 54, which have joint assemblies 66 disposed in crosswise-extruded receptacles 68. The structures 54 illustrated in FIGS. 15 and 16 may be extruded as single-socket-ended or double-socket-ended linkages, which then incorporate various elastomeric and metallic joint members. If the structures 54 are extruded and cut from the geometry 50 (i.e., double-socket-ended linkages of FIGS. 12-14), then the structures 54 may be cut mid-length to provide the single-socket-ended structures 54 illustrated in FIGS. 15 and 16. In either case, a lengthwise linkage receptacle can then be drilled and threaded into an end of the structure 54 opposite the crosswise receptacle (e.g., receptacles 60, 62 and 68).

The structure 54 illustrated in FIG. 15 is configured for a rod-based linkage application, such as automotive suspension and steering linkages. As illustrated, the joint assembly 66 embodies a studded joint structure 70, which has a ball member 72 disposed in the crosswise-extruded receptacle 68 and a threaded stud 74 extending from the ball member 72. The ball member 72 may embody any suitable attachment members, such as washers, flanges, pin/hole coupling mechanisms, nut/bolt coupling mechanisms, or tool-free coupling mechanisms. For example, the ball member 72 may embody an elastomeric ball having grooves for compressibly inserting the ball member 72 into the crosswise-extruded receptacle 68. The structure 54 of FIG. 15 also has a rod linkage end 76 for coupling with a rod member 78. The rod linkage end 76 and rod member 78 may comprise any suitable coupling mechanisms, such as male/female threads.

The structure 54 illustrated in FIG. 16 is configured for a bolt-based linkage application. As illustrated, the joint assembly 66 embodies a bushing/grommet structure 80, which has a ring member 82 disposed in the crosswise-extruded receptacle 68 for coupling to a desired linkage or mechanical device. For example, the ring member 82 has a linkage receptacle 84 (i.e., a cylindrical crosswise passage) to support a pin/bolt coupling member or a rod end of the desired linkage. The ring member 82 also may embody an elastomeric material or flexible structure, which has a linkage support ring 86 disposed within the linkage receptacle 84. Accordingly, the joint assembly 66 may provide a flexible intercoupling between the structure 54 and the desired linkage or mechanical device. The structure 54 also has a lengthwise coupling assembly 88, which may comprise a variety of bushings, grommets, insulators, threaded receptacles and studs, washers, spacers, and other desired metallic or elastomeric linkage members. As illustrated, the lengthwise coupling assembly 88 comprises washers 90 and 92 disposed about flexible members 94 and 96. Alternatively, the lengthwise coupling assembly 88 may comprise one or more integral washer-grommet assemblies 98, such as illustrated in FIG. 17. The integral washer-grommet assembly 98 has a washer 100 integrally retained within a flexible member 102, which may embody any suitable flexible material and structure. In either configuration of the lengthwise coupling assembly 88, the structure 54 includes a receptacle 104 for a linkage member 106 (e.g., a bolt). As illustrated, the receptacle 104 extends through the lengthwise coupling assembly 88 and threadingly into the structure 54 for coupling with the linkage member 106. Accordingly, the structure 54 can be flexibly coupled to the desired linkage or mechanical device via the joint assembly 66 and the lengthwise coupling assembly 88.

While the invention may be susceptible to various modifications and alternative forms, specific embodiments have been shown by way of example in the drawings and have been described in detail herein. However, it should be understood that the invention is not intended to be limited to the particular forms disclosed. The present invention may incorporate any suitable linkage/joint structure, fixed or stationary, and any suitable material may be used in forming the desired structure. Moreover, any suitable manufacturing systems, material extrusion devices, molding and casting devices, and other manufacturing techniques may be used within the scope of the present invention. Accordingly, the invention is to cover all modifications, equivalents, and alternatives falling within the spirit and scope of the invention as defined by the following appended claims.

What is claimed is:

1. A mechanical linkage, comprising
an elongated extruded member comprising a structural cross-section and a linkage end, wherein the structural cross-section is configured to support the linkage end under a mechanical load.

2. The mechanical linkage of claim 1, wherein the linkage end comprises an integral joint member formed by the structural cross-section.

3. The mechanical linkage of claim 1, wherein the linkage end comprises an integral socket formed by the structural cross-section.

4. The mechanical linkage of claim 3, wherein the integral socket comprises an elastomeric joint.

5. The mechanical linkage of claim 3, wherein the integral socket comprises a bushing.

6. The mechanical linkage of claim 3, wherein the integral socket comprises a grommet.

7. The mechanical linkage of claim 3, wherein the integral socket h as a square geometry.

8. The mechanical linkage of claim 3, wherein the integral socket has a geometry characterized by a plurality of superimposed squares.

9. The mechanical linkage of claim 3, comprising a desired device having a modular connector disposed in the integral socket.

10. The mechanical linkage of claim 9, wherein the desired device is a joint member.

11. The mechanical linkage of claim 10, wherein the joint member comprises a molded ball.

12. The mechanical linkage of claim 10, wherein the elongated extruded member comprises a metal and the joint member comprises an elastomeric material.

13. The mechanical linkage of claim 9, wherein the desired device comprises a modular socket device having a desired socket geometry.

14. The mechanical linkage of claim 13, wherein the desired socket geometry has an enclosed form.

15. The mechanical linkage of claim 13, wherein the desired socket geometry has an open form.

16. The mechanical linkage of claim 1, wherein the elongated extruded member is extruded lengthwise.

17. The mechanical linkage of claim 16, wherein the linkage end is formed by the structural cross-section at both lengthwise ends of the elongated extruded member.

18. The mechanical linkage of claim 17, wherein the linkage end comprises an integral joint.

19. The mechanical linkage of claim 17, wherein the linkage end comprises an integral socket.

20. The mechanical linkage of claim 17, comprising modular devices disposed in the linkage end at both lengthwise ends of the elongated extruded member.

21. The mechanical linkage of claim 20, wherein the modular devices comprise an elastomeric joint.

22. The mechanical linkage of claim 20, wherein the modular devices comprise a socket device.

23. The mechanical linkage of claim 20, wherein the modular devices are positioned in different angular orientations.

24. The mechanical linkage of claim 1, wherein the elongated extruded member is extruded crosswise.

25. The mechanical linkage of claim 24, wherein the linkage end is formed by the structural cross-section at both lengthwise ends of the elongated extruded member.

26. The mechanical linkage of claim 25, wherein the elongated extruded member is twisted about a lengthwise axis to provide a desired angle between the lengthwise ends.

27. The mechanical linkage of claim 25, wherein the linkage end comprises an integral joint structure.

28. The mechanical linkage of claim 25, wherein the linkage end comprises an integral socket.

29. The mechanical linkage of claim 28, comprising modular devices disposed in the integral sockets at both lengthwise ends of the elongated extruded member.

30. The mechanical linkage of claim 29, wherein at least one of the modular devices comprises an elastomeric joint.

31. The mechanical linkage of claim 29, wherein at least one of the modular devices comprise a socket device.

32. A modular linkage system, comprising:
an extruded arm comprising first and second linkage sockets at opposite lengthwise ends of the extruded arm, wherein the first and second linkage sockets have a geometry configured for multi-angular orientations.

33. The modular linkage system of claim 32, wherein at least one socket of the first and second linkage sockets comprises an integral joint structure.

34. The modular linkage system of claim 33, wherein the integral joint structure comprises an elastomeric member.

35. The modular linkage system of claim 32, wherein at least one socket of the first and second linkage sockets extends crosswise through the extruded arm.

36. The modular linkage system of claim 32, wherein at least one socket of the first and second linkage sockets extends lengthwise through at least a portion of the extruded arm.

37. The modular linkage system of claim 32, comprising a socket device having a modular connector end disposed in at least one socket of the first and second linkage sockets.

38. The modular linkage system of claim 32, comprising a joint structure disposed in at least one socket of the first and second linkage sockets.

39. The modular linkage system of claim 38, wherein the joint structure comprises an elastomeric joint member.

40. The modular linkage system of claim 32, wherein the extruded arm is extruded lengthwise.

41. The modular linkage system of claim 40, wherein the extruded arm comprises a square extruded cross-section.

42. The modular linkage system of claim 40, wherein the extruded arm comprises an extruded cross-section, which is geometrically characterized by a plurality of superimposed squares.

43. The modular linkage system of claim 40, wherein the first and second linkage sockets comprise an operable socket device.

44. The modular linkage system of claim 40, comprising a modular device disposed in at least one socket of the first and second linkage sockets.

45. The modular linkage system of claim 44, wherein the modular device comprises a mechanical joint assembly comprising an elastomeric member.

46. The modular linkage system of claim 44, wherein the modular device comprises an operable socket device.

47. The modular linkage system of claim 44, comprising an opposite modular device disposed in a remaining socket of the first and second linkage sockets, wherein the modular device and opposite modular device are positioned in different angular orientations.

48. The modular linkage system of claim 32, wherein the extruded arm is extruded crosswise.

49. The modular linkage system of claim 48, wherein the extruded arm comprises a twisted portion to position the first and second linkage sockets at different angular orientations.

50. The modular linkage system of claim 48, wherein at least one of the first and second linkage sockets comprises an integral socket device having a polygonal receptacle.

51. The modular linkage system of claim 48, wherein at least one of the first and second linkage sockets comprises a mechanical joint assembly.

52. The modular linkage system of claim 51, wherein the mechanical joint assembly comprises an elastomeric member.

53. A method of forming a modular linkage assembly, comprising:
extruding an elongated member having at least one linkage section at one of opposite lengthwise ends of the elongated member.

54. The method of claim 53, comprising forming a material extrusion device having a desired cross-section for extruding the elongated member.

55. The method of claim 53, comprising providing a modular device configured for insertion into the at least one linkage section.

56. The method of claim 55, wherein providing the modular device comprises extruding a socket structure having a modular connector end.

57. The method of claim 55, wherein providing the modular device comprises molding a socket structure having a modular connector end.

58. The method of claim 55, wherein providing the modular device comprises forming a mechanical joint structure.

59. The method of claim 53, wherein extruding the elongated member having at least one linkage section comprises extruding first and second sockets at the opposite lengthwise ends.

60. The method of claim 59, wherein extruding first and second sockets comprises extruding the elongated member lengthwise through a material extrusion device.

61. The method of claim 60, comprising cutting the elongated member at a desired length.

62. The method of claim 60, wherein extruding the elongated member lengthwise comprises rotatingly extruding the elongated member lengthwise to provide an angular differential between the socket geometry at opposite ends of the elongated member.

63. The method of claim 60, wherein extruding the elongated member lengthwise comprises forming a lateral cross-section having a socket geometry configured for supporting a modular device.

64. The method of claim 63, wherein forming the lateral cross-section having the socket geometry comprises forming an internal cavity having a square geometry.

65. The method of claim 63, wherein forming the lateral cross-section having the socket geometry comprises forming an internal cavity having a geometry characterized by a plurality of superimposed squares.

66. The method of claim 53, comprising inserting a modular socket device into the at least one linkage section.

67. The method of claim 53, comprising inserting an elastomeric joint into the at least one linkage section.

68. The method of claim 53, wherein extruding the elongated member comprises extruding the elongated member crosswise through a material extrusion device.

69. The method of claim 68, comprising cutting the elongated member at a desired thickness.

70. The method of claim 69, wherein extruding the elongated member having at least one linkage section comprises extruding an integral socket device.

71. The method of claim 69, wherein extruding the elongated member having at least one linkage section comprises extruding an integral socket arm for a modular device.

72. The method of claim 71, comprising providing the modular device for removable coupling with the integral socket arm.

73. The method of claim 68, wherein extruding the elongated member having at least one linkage section comprises extruding first and second linkage sections at the opposite lengthwise ends.

74. The method of claim 73, comprising twisting the elongated member to position the first and second linkage sections at different angular orientations.
